(19) United States
(12) Patent Application Publication
(10) Pub. No.: US 2013/0124822 A1
(43) Pub. Date: May 16, 2013

(54) CENTRAL PROCESSING UNIT (CPU) ARCHITECTURE AND HYBRID MEMORY STORAGE SYSTEM

(71) Applicant: Moon J. Kim, Wappingers Falls, NY (US)

(72) Inventor: Moon J. Kim, Wappingers Falls, NY (US)

(21) Appl. No.: 13/295,668

(22) Filed: Nov. 14, 2011

(51) Int. Cl. G06F 15/76; G06F 9/06

(52) U.S. Cl. 712/1; 712/E09.003

(57) ABSTRACT

In general, embodiments of the present invention relate to CPU and/or digital memory architecture. Specifically, embodiments of the present invention relate to various approaches for adapting current CPU designs. In one embodiment, the CPU architecture comprises a storage unit coupled to a CPU and/or a memory translator but no memory unit. In another embodiment, the architecture comprises a memory unit coupled to a CPU and/or a storage mapper, but no storage unit. In yet another embodiment, the CPU can be coupled to a memory unit, a storage unit and/or a memory-to-storage mapper. Regardless, the embodiments can utilize I/O hubs, convergence I/Os and/or memory controllers to connect/couple the components to one another. In addition, a tag can be provided for the memory space. The tag can include fields for a virtual header length, a virtual address header, and/or a physical address.

### FIELD OF THE INVENTION

The present invention relates generally to memory architecture. Specifically, embodiments of the present invention relate to CPU designs.

### BACKGROUND OF THE INVENTION

Currently, storage architectures may have multiple drawbacks. For example, existing approaches can be slow and have too many hierarchical levels to reach stored data. Moreover, existing approaches can be limited in terms of memory space and be expensive. One potential source of these issues is the direct attachment of memory to the CPU. Such an arrangement not only renders the architecture localized and inefficient, but the arrangement is difficult to expand and can be inefficient. Moreover, this arrangement can be expensive and subject to loss at power outage.

Heretofore, various approaches have unsuccessfully tried to alleviate these issues.

U.S. Pat. No. 6,581,137 discloses a data storage system that utilizes an interface between a set of disk drives and a host computer. The interface includes a central processing unit main memory consisting of an SDRAM and an RDRAM.

U.S. Pat. No. 6,065,097 discloses a computer system with an internal memory controller that interfaces between the CPU, external cache, and primary memory “through a single unified memory bus.”

U.S. Pat. No. 5,564,015 discloses a computer system that utilizes a “CPU activity monitor”. This monitor receives mode signals from the CPU, cache miss signals from a cache memory system, and a clock signal. Improved CPU monitoring is the intention of this invention with the potential to reduce power consumption of the computer system based upon the monitoring.

U.S. Pat. No. 4,476,526 discloses a buffered cache memory subsystem. Solid-state cache memory is interfaced to a microprocessor memory storage director. The microprocessor memory storage director interfaces with control modules for “controlling operation of a long-term data storage device such as a disk drive.” In one embodiment, memory data is saved in the cache memory option when it is “expected to be the subject of a future host request” and is intended to improve operational efficiency.

U.S. Pat. No. 4,460,959 discloses a logic control system that utilizes cache memory and a “transfer control logic unit” that manages the transmission of “procedural information” and CPU instructions. The logic control system uses a common communication bus between the CPU and I/O controllers & memory units.

U.S. Pat. No. 7,861,040 discloses a cache control memory apparatus that includes cache memory in the volatile and nonvolatile memory modules.

U.S. Pat. No. 7,581,064 discloses a method using cache data to optimize access of cache memory. Software is utilized to analyze memory utilization. This analysis is used to optimize memory access.

U.S. Pat. No. 6,836,816 discloses method for utilizing flash memory as a low-latency cache device that is “on an integrated circuit”. The patent claims to “improve average access times between a processor and the main memory.” The cache is designed to interface with the process using a standard bus negating the need for a redesigned memory bus that would otherwise be necessary.

U.S. Pat. No. 6,591,340 discloses an improved memory management unit that includes the use of virtual cache memory and “a translation lookaside buffer”. The method relies on permission rights for memory data access.

U.S. Pat. No. 6,567,889 discloses a modified storage controller with cache memory. In one embodiment, a “virtual solid state disk storage device is a single virtual disk drive for storing controller based information”. Redundancy of the storage controller is achieved with a “standard battery backup and redundant controller features of RAID controller technology”.

U.S. Pat. No. 5,802,560 discloses a computer system apparatus that uses a memory chip with multiple SRAM caches linked to a single DRAM memory block. The design uses separate memory buses between the combined memory devices and the CPU or PCI controller.

U.S. Patent Application 20110202707 discloses a hybrid storage device comprised of SSD memory, disc-type memory, and a “hybrid data storage device controller” that is in communication with both memory devices and a NVMHCI controller.

### SUMMARY OF THE INVENTION

In general, embodiments of the present invention relate to CPU and/or digital memory architecture. Specifically, embodiments of the present invention relate to various approaches for adapting current CPU designs. In one embodiment, the CPU architecture comprises a storage unit coupled to a CPU and/or a memory translator but no memory unit. In another embodiment, the architecture comprises a memory unit coupled to a CPU and/or a storage mapper, but no storage unit. In yet another embodiment, the CPU can be coupled to a memory unit, a storage unit and/or a memory-to-storage mapper. Regardless, the embodiments can utilize I/O hubs, convergence I/Os and/or memory controllers to connect/couple the components to one another. In addition, a tag can be provided for the memory space. The tag can include fields for a virtual header length, a virtual address header, and/or a physical address.

A first aspect of the present invention provides a central processing unit (CPU) architecture, comprising: a CPU; a convergence input/output (I/O) coupled to the CPU; and a storage unit coupled to the convergence I/O, wherein the CPU architecture does not comprise a memory unit.

A second aspect of the present invention provides a central processing unit (CPU) architecture, comprising: a CPU; a convergence input/output (I/O) coupled to the CPU; and a memory unit coupled to the convergence I/O, wherein the CPU architecture does not comprise a storage unit.

A third aspect of the present invention provides a central processing unit (CPU) architecture, comprising: a CPU; a convergence input/output (I/O) coupled to the CPU; a memory unit indirectly coupled to the CPU; and a storage unit coupled to the convergence I/O.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a general purpose computing system.

FIG. 2A depicts a conventional CPU design.

FIG. 2B depicts a CPU design according to an embodiment of the present invention.

FIG. 2C depicts another CPU design according to an embodiment of the present invention.

FIG. 3A depicts a conventional CPU design.

FIG. 3B depicts a CPU design according to an embodiment of the present invention.

FIG. 3C depicts another CPU design according to an embodiment of the present invention.

FIG. 4A depicts a conventional CPU design.

FIG. 4B depicts a CPU design according to an embodiment of the present invention.

FIG. 4C depicts another CPU design according to an embodiment of the present invention.

FIG. 5A depicts a conventional CPU design.

FIG. 5B depicts a CPU design according to an embodiment of the present invention.

FIG. 5C depicts a header configuration according to an embodiments of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

In general, embodiments of the present invention relate to CPU and/or digital memory architecture. Specifically, embodiments of the present invention relate to various approaches for adapting current CPU designs. In one embodiment, the CPU architecture comprises a storage unit coupled to a CPU and/or a memory translator but no memory unit. In another embodiment, the architecture comprises a memory unit coupled to a CPU and/or a storage mapper, but no storage unit. In yet another embodiment, the CPU can be coupled to a memory unit, a storage unit and/or a memory-to-storage mapper. Regardless, the embodiments can utilize I/O hubs, convergence I/Os and/or memory controllers to connect/couple the components to one another. In addition, a tag can be provided for the memory space. The tag can include fields for a virtual header length, a virtual address header, and/or a physical address.

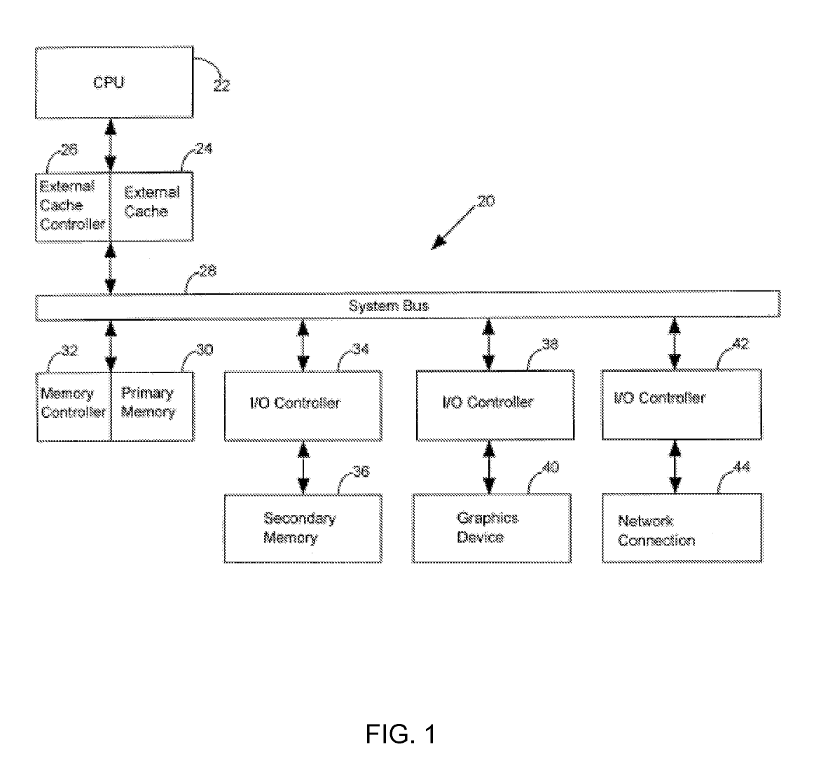

FIG. 1 is an illustration of a general purpose computer 20. The computer 20 includes a central processing unit (CPU) 22. The CPU 22 executes instructions of a computer program. Each instruction is located at a memory address. Similarly, the data associated with an instruction is located at a memory address. The CPU 22 accesses a specified memory address to fetch the instruction or data stored there.

Most CPUs include an on-board memory called a cache. The cache stores a set of memory addresses and the instructions or data associated with the memory addresses. If a specified address is not in the internal, or L1 cache, then the CPU 22 looks for the specified address in an external cache, also called an L2 cache 24. The external cache is typically implemented using Static Random Access Memories (SRAMs). Standard SRAMs are simply storage devices. Thus, they are operated with a separate circuit known as an external cache controller 26.

If the address is not in the external cache 24 (a cache miss), then the external cache 24 requests access to a system bus 28. When the system bus 28 becomes available, the external cache 24 is allowed to route its address request to the primary memory 30. The primary memory 30 is typically implemented using Dynamic Random Access Memories (DRAMs). As in the case of SRAMs, DRAMs are simply memory devices. Thus, they are operated with a separate circuit known as an external memory controller 32.

The data output from the primary memory 30 is applied to the system bus 28. It is then stored in the external cache 24 and is passed to the CPU 22 for processing. The processing described in reference to FIG. 1 must be performed for every address request. Indeed, if the address request is not found in the primary memory 30, similar processing is performed by an input/output controller 34 associated with a secondary memory 36.

As shown in FIG. 1, there are additional devices connected to the system bus 28. For example, FIG. 1 illustrates an input/output controller 38 operating as an interface between a graphics device 40 and the system bus 28. In addition, the figure illustrates an input/output controller 42 operating as an interface between a network connection circuit 44 and the system bus 28.

The multiple connections to the system bus 28 result in a relatively large amount of traffic. It would be desirable to remove memory transactions from the system bus 28 in order to reduce traffic on the system bus 28. It is known to remove memory transactions from the system bus 28 by using a separate memory bus for external cache 24 and a separate memory bus for primary memory 30. This approach results in a relatively large number of CPU package pins. It is important to reduce the number of CPU package pins. Thus, it would be highly desirable to reduce the traffic on the system bus without increasing the number of CPU package pins. In addition, it would be desirable to eliminate the need for the external logic associated with external cache and primary memories.

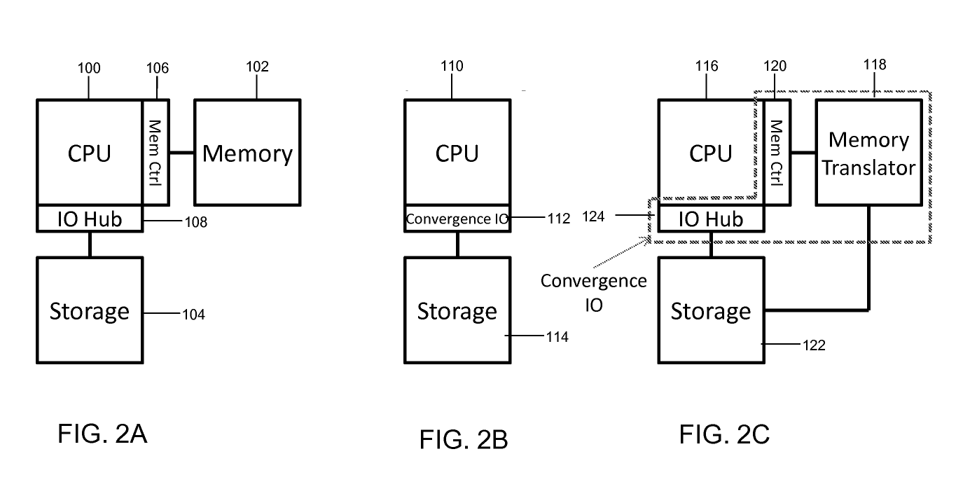

Referring now to FIG. 2A, a conventional CPU architecture is shown. As depicted, CPU 100 is coupled to storage unit 104 via I/O hub 108 and to memory unit 102 via memory controller 106. This conventional design can be very inefficient and slow. FIG. 2B shows a CPU architecture according to one embodiment of the present invention. As depicted, CPU 110 is coupled to storage unit 114 via convergence I/O 112. Thus, memory unit 102 can be removed from the system and CPU 110's memory request can be directly handled by the storage unit 114. In another embodiment shown in FIG. 2C, a memory translator 118 can be coupled to CPU 116 via memory controller 120 while storage unit 122 remains coupled to CPU 116 via I/O hub 124. In this latter embodiment, memory translator 118 can be used to map the CPU 116's memory request to storage block.

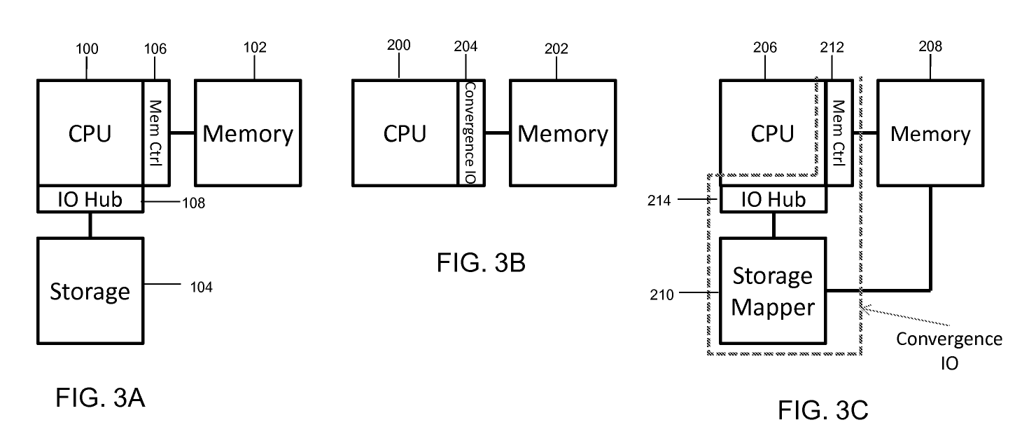

FIGS. 3A-C show a similar set of architectures. Referring now to FIG. 3A, the conventional CPU architecture is shown again. As depicted, CPU 100 is coupled to storage unit 104 via I/O hub 108 and to memory unit 102 via memory controller 106. As mentioned, this conventional design can be very inefficient and slow. FIG. 3B shows a CPU architecture according to another embodiment of the present invention. As depicted, CPU 200 is coupled to memory unit 202 via convergence I/O 204. Thus, storage units 114 and 122 shown in FIGS. 2B-C can be removed from the system and CPU 200 memory request can be directly handled by memory unit 202. In another embodiment shown in FIG. 3C, a storage mapper 210 can be coupled to CPU 206 via I/O hub 214 while memory unit 208 remains coupled to CPU 206 via memory controller 212. In this latter embodiment, storage mapper 210 can be used to map the CPU 206's storage request to memory block 208.

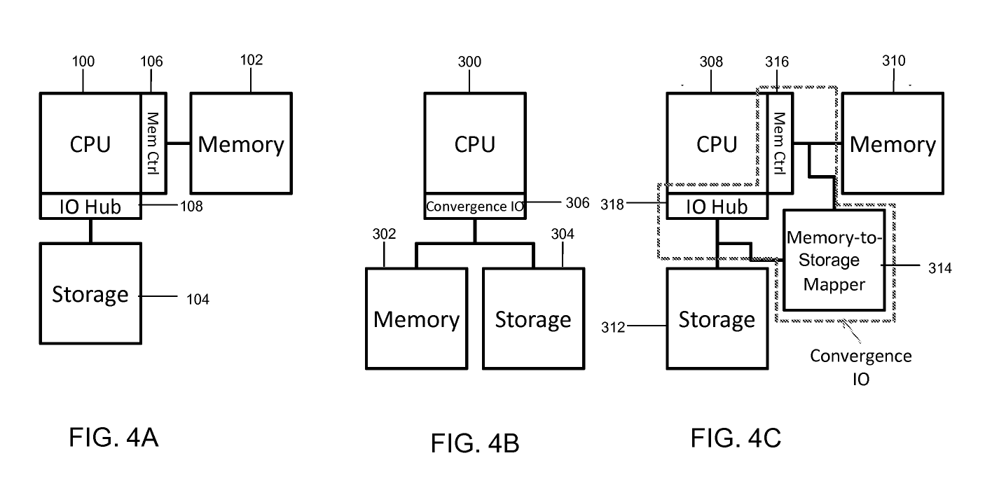

FIGS. 4A-C show a similar set of architectures. Referring now to FIG. 4A, the conventional CPU architecture is shown again. As depicted, CPU 100 is coupled to storage unit 104 via I/O hub 108 and to memory unit 102 via memory controller 106. As mentioned, this conventional design can be very inefficient and slow. FIG. 4B shows a CPU architecture according to another embodiment of the present invention. As depicted, CPU 300 is coupled to memory unit 302 and storage unit 304 via convergence I/O 306. In another embodiment shown in FIG. 4C, a memory-to-storage mapper 314 can be coupled to CPU 308 via a convergence I/O, memory unit 310 is coupled to CPU 308 via memory controller 316, and storage unit 312 is coupled to CPU 308 via I/O hub 318.

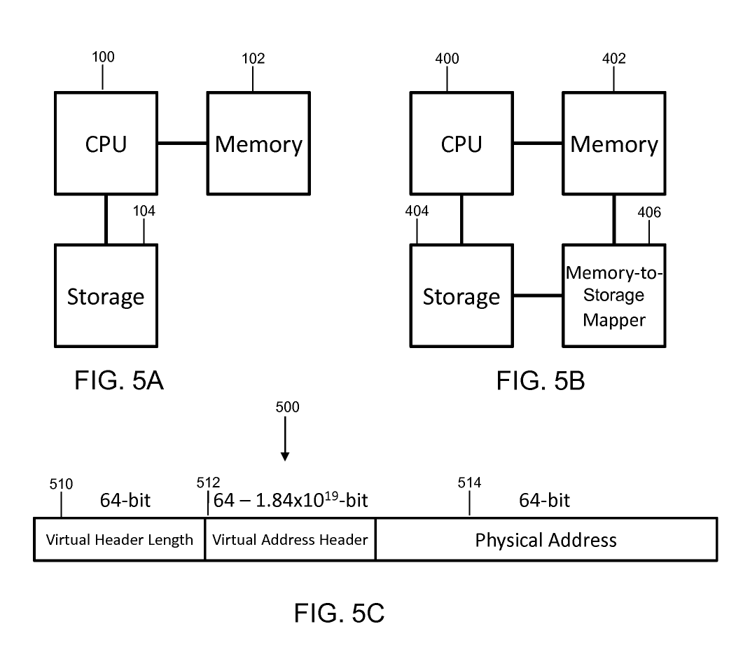

Referring to FIG. 5A and FIG. 5B, a generalized version of FIG. 4A and FIG. 4B, respectively, are shown. Specifically, FIG. 5A shows CPU 100, memory unit 102, and storage unit 104. FIG. 5B shows CPU 400, memory unit 402, storage unit 404, and memory-to-storage mapper 406. As shown in FIG. 5C, memory space is extended and an additional description tag is stored in specified register and memory location. Specifically, tag 500 comprises a virtual header length field 510, a virtual address header field 512, and a physical address field 514. Under this embodiment, memory space and threads are virtualized within the limited memory space. A thread sees physical address space, while the operating system maintains virtualization of threads. The total address space is 2⁶⁴*2̂(2⁶⁴). As further shown in FIG. 5B, storage unit 104 is connected to memory unit 402 via memory-to-storage mapper 406. Moreover, memory can be a large off-CPU cache of storage.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A central processing unit (CPU) architecture, comprising:
a CPU;
a convergence input/output (I/O) coupled to the CPU; and
a storage unit coupled to the convergence I/O, wherein the CPU architecture does not comprise a memory unit.

2. The CPU architecture of claim 1 further comprising a memory controller coupled to the CPU.

3. The CPU architecture of claim 2, further comprising a memory translator coupled to the memory controller.

4. The CPU architecture of claim 3, the memory translator being used to map convention memory requests to blocks of the storage unit.

5. The CPU architecture of claim 1, the convergence I/O comprising an I/O hub.

6. A central processing unit (CPU) architecture, comprising:
a CPU;
a convergence input/output (I/O) coupled to the CPU; and
a memory unit coupled to the convergence I/O, wherein the CPU architecture does not comprise a storage unit.

7. The CPU architecture of claim 6, further comprising a memory controller coupled to the CPU.

8. The CPU architecture for claim 6 further comprising an I/O hub coupled to the CPU.

9. The CPU architecture of claim 8, further comprising a storage mapper coupled to the I/O hub.

10. The CPU architecture of claim 9, the storage mapper being configured to map CPU storage requests to blocks of the memory unit.

11. A central processing unit (CPU) architecture, comprising:
a CPU;
a convergence input/output (I/O) coupled to the CPU;
a memory unit indirectly coupled to the CPU; and
a storage unit coupled to the convergence I/O.

12. The CPU architecture of claim 11, further comprising a memory controller coupled to the CPU.

13. The CPU architecture of claim 12, the memory unit being coupled to the CPU via the memory controller.

14. The CPU architecture of claim 11, the memory unit being coupled to the CPU via the convergence I/O.

15. The CPU architecture for claim 11, the convergence I/O comprising an I/O hub.

16. The CPU architecture of claim 15, further comprising a memory-to-storage mapper coupled to the I/O hub.

17. The CPU architecture of claim 16, the memory-to-storage mapper being configured to map the memory unit to the storage unit.

18. The CPU architecture of claim 11, further comprising a tag associated with data stored in the memory unit.

19. The CPU architecture of claim 18, the tag comprising:
a virtual header length;
a virtual address header; and
a physical address.
